(19) United States
(12) Patent Application Publication
(10) Pub. No.: US 2017/0310179 A1
(43) Pub. Date: Oct. 26, 2017

(54) ROTOR OF ROTARY ELECTRIC MACHINE

(71) Applicant: TOYOTA JIDOSHA KABUSHIKI KAISHA, Toyota-shi, Aichi-ken (JP)

(72) Inventors: Toshinori OKOUCHI, Toyota-shi (JP); Hiroyuki HATTORI, Okazaki-shi (JP)

(73) Assignee: TOYOTA JIDOSHA KABUSHIKI KAISHA, Toyota-shi, Aichi-ken (JP)

(21) Appl. No.: 15/520,733

(22) PCT Filed: Aug. 28, 2015
(86) PCT No.: PCT/JP2015/004379

§ 371 Date: Apr. 20, 2017

(30) Foreign Application Priority Data
Oct. 23, 2014 (JP) 2014-215985

(51) Int. Cl. H02K 1/32; H02K 1/27

(52) U.S. Cl. CPC H02K 1/32; H02K 1/276

(57) ABSTRACT

In a rotor core (12) of a rotor (10), a core interior refrigerant path is formed. The core interior refrigerant path includes a first refrigerant path (22) formed for every magnetic pole and extending along each q axis from the outer circumferential end of the rotor core (12) toward the inner circumference of the rotor core (12); a second refrigerant path (24) formed for every other magnetic pole and extending along a d axis from the inner circumferential end of the rotor core (12) to a position closer to the inner circumference than the permanent magnet (16) is; and a third refrigerant path (26) extending in a rotor circumferential direction at a position displaced in the rotor shaft direction relative to the first refrigerant path (22) to provide fluid communication between the first refrigerant path (22) and the second refrigerant path (24).

### TECHNICAL FIELD

The present invention relates to a rotor of a rotary electric machine including a rotor core, and a permanent magnet embedded near the outer circumference of the rotor core.

### BACKGROUND ART

In a permanent magnetic synchronous rotary electric machine including a permanent magnet embedded inside a rotor core, when the temperature of the rotor increases as the rotary electric machine is driven, the magnetic performance is deteriorated, which results in not only decrease of torque and efficiency, but also demagnetization of the permanent magnet when the temperature becomes high. Employment of a magnet having high coercivity can avoid the problem of demagnetization. However, in such a case, it is necessary to increase the content rate of heavy rare earth elements, which increases cost.

In view of the above, conventionally, various structures have been suggested in order to cool a rotary electric machine. For example, Patent Document 1 discloses a technique for cooling a rotor by discharging oil supplied from an oil supply path formed inside the rotary shaft, through a plurality of cooling oil paths formed inside the rotary core. In Patent Document 1, a cooling oil path extends on a d axis of the rotary electric machine. A cooling oil path extending on one d axis may be formed, using a slot extending along the d axis from the inner circumferential end of one electromagnetic steel plate to the outer circumferential end of the same or using a plurality of slots formed displaced from each other in the diameter direction range for every two or more successively aligned electromagnetic steel plates. Patent Document 2 discloses a similar technique.

Patent Document 3 as well discloses a technique for cooling a rotor by discharging oil supplied from an oil supply path formed inside the rotary shaft, through a plurality of cooling oil paths formed inside the rotary core. In Patent Document 3, cooling oil paths each extending along a q axis are formed by forming slots each extending along the q axis of the rotary electric machine so as to be displaced from each other in the diameter direction range for every two or more successively aligned electromagnetic steel plates.

### CITATION LIST

### Patent Literature

[PTL 1]
JP 2006-067777 A
[PTL 2]
JP 2008-228523 A
[PTL 3]
JP 2008-228522 A

### SUMMARY OF INVENTION

### Technical Problem

In a permanent magnetic synchronous rotary electric machine, as is well known, reluctance torque is used in addition to magnetic torque due to a permanent magnet. In order to ensure a large magnetic torque, it is necessary to ensure a d axis magnetic path traversing a q axis. Meanwhile, in order to ensure a large reluctance torque, it is necessary to ensure a q axis magnetic path traversing a d axis.

However, according to the conventional techniques disclosed in Patent Documents 1, 2, a slit that functions as a refrigerant channel is formed on the way of a q axis magnetic path and the slit forms an air gap of the magnetic path. This results in decrease of the reluctance torque. According to the technique disclosed in Patent Document 3, a slit that functions as a refrigerant channel is formed on the way of a d axis magnetic path and the slit forms an air gap of the magnetic path. This results in decrease of the magnetic torque. According to the techniques disclosed in Patent Documents 1 to 3, a cooling oil path is formed for every magnetic pole. In this case, it is necessary to form many holes (cooling oil paths) in the rotary shaft and the rotor core. This results in a problem of deteriorated strength of the rotor core and the rotary shaft.

In view of the above, the present invention aims to provide a rotor of a rotary electric machine capable of increasing cooling performance without deteriorating the output performance and strength of a motor.

### Solution to Problem

A rotor of a rotary electric machine according to the present invention is a rotor of a rotary electric machine including a rotor core and a permanent magnet embedded in the rotor core and being rotatably supported by a rotary shaft, wherein the rotor core includes a core interior refrigerant path formed therein for introducing refrigerant supplied from a shaft interior refrigerant path formed in the rotary shaft to an outer circumferential end of the rotor core to discharge into a gap defined between the outer circumferential end and a stator, and the core interior refrigerant path includes a first refrigerant path formed for every magnetic pole of the rotary electric machine, and extending along each q axis of the rotary electric machine, from the outer circumferential end of the rotor core toward the inner circumference of the rotor core;

a second refrigerant path formed for every other magnetic pole of the rotary electric machine, and extending in a position displaced in the rotor circumferential direction relative to the first refrigerant path, from the inner circumferential end of the rotor core to a position closer to the inner circumference than the permanent magnet is; and a third refrigerant path extending in the rotor circumferential direction at a position displaced in the rotor shaft direction relative to the first refrigerant path to provide fluid communication between the first refrigerant path and the second refrigerant path.

In a preferable embodiment, the core interior refrigerant path may be formed at only one position in the rotor shaft direction. In another preferable embodiment, the second refrigerant path may extend along a d axis of the rotary electric machine.

In another preferable embodiment, the rotor core may be formed by stacking a plurality of electromagnetic steel plates in the rotor shaft direction, and a first steel plate including the first refrigerant path formed therein or a first steel plate set including a plurality of first steel plates stacked and a second steel plate including the third refrigerant path formed therein or a second steel plate set including a plurality of second steel plates stacked may be disposed adjacent to each other in the rotor shaft direction.

In this case, it is desired that the third refrigerant path includes a one side third refrigerant path for providing communication between the second refrigerant path and a first refrigerant path positioned adjacent to the second refrigerant path on one side of the second refrigerant path in the rotor circumferential direction, and an other side third refrigerant path for providing communication between the second refrigerant path and a first refrigerant path positioned adjacent to the second refrigerant path on the other side of the second refrigerant path in the rotor circumferential direction, and the one side third refrigerant path and the other side third refrigerant path are formed in different electromagnetic steel plates.

It is also desired that a one side second steel plate including the one side third refrigerant path formed therein or a steel plate set including a plurality of one side second steel plates stacked and an other side second steel plate including the other side third refrigerant path formed therein or a steel plate set including a plurality of other side second steel plates stacked are disposed on respective sides in the rotor shaft direction of the first steel plate including the first refrigerant path formed therein or the first steel plate set including the plurality of first steel plates stacked. Further, it is also desired that the other side second steel plate is a steel plate resulting from stacking a steel plate having the same shape as that of the one side second steel plate so as to be laterally flipped relative to the one side second steel plate. In another preferred embodiment, the first refrigerant path and the second refrigerant path may be formed in the same electromagnetic steel plate.

### Advantageous Effects of Invention

According to the present invention, it is possible to effectively utilize both reluctance torque and magnet torque, as it is possible to keep low the magnetic resistance of both of the q axis magnetic path and the d axis magnetic path. Further, it is possible to prevent decrease in the strength of the electromagnetic steel plate and the rotary shaft, as the second refrigerant path is formed for every other magnetic pole. As a result, it is possible to improve cooling performance without deteriorating the output performance and strength of the motor.

### BRIEF DESCRIPTION OF DRAWINGS

FIG. 1 is a horizontal cross sectional view of a rotor according to a first embodiment of the present invention.

FIG. 2 is a cross sectional view of a rotary electric machine along line X-X in FIG. 1.

FIG. 3 shows a structure of a first steel plate and that of a second steel plate in the first embodiment.

FIG. 4 is a vertical cross sectional view of a rotor according to a second embodiment of the present invention.

FIG. 5 shows a structure of a first steel plate in the second embodiment.

FIG. 6 shows a structure of a third steel plate in the second embodiment.

FIG. 7 shows another structure of the first steel plate and that of the second steel plate.

FIG. 8 is a horizontal cross sectional view of a rotor core according to another embodiment.

FIG. 9 is a horizontal cross sectional view of a rotor core according to still another embodiment.

FIG. 10 shows a structure of an electromagnetic steel plate of a conventional rotor.

FIG. 11 shows a structure of an electromagnetic steel plate of a conventional rotor.

### DESCRIPTION OF EMBODIMENTS

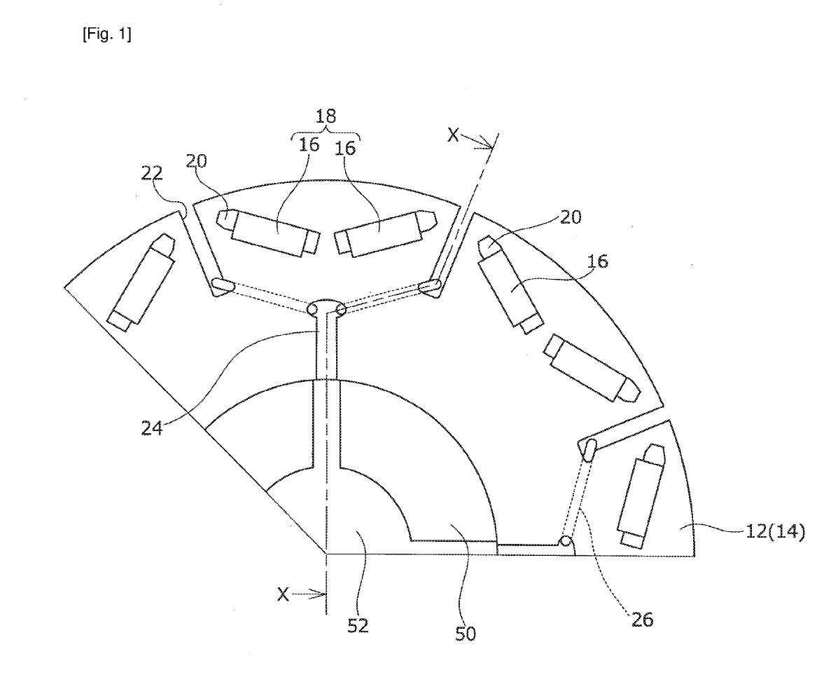

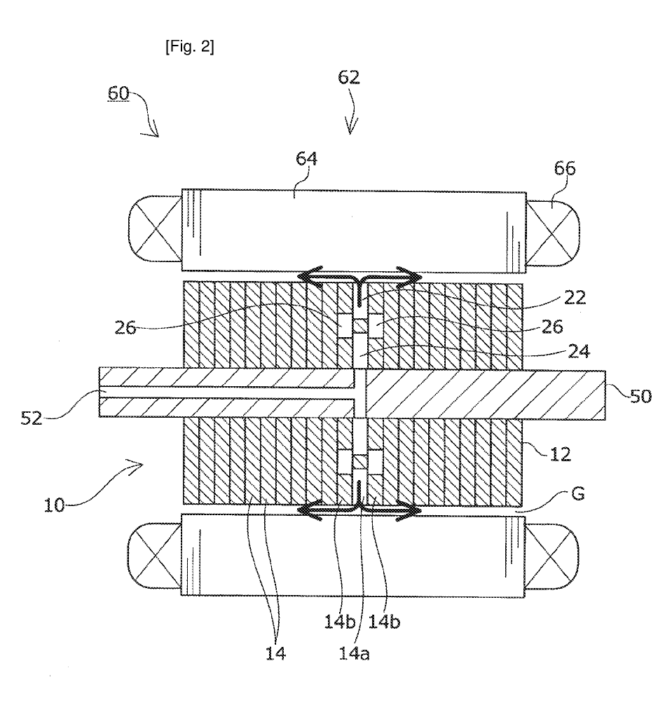

In the following, embodiments of the present invention will be described with reference to the drawings. FIG. 1 is a horizontal cross sectional view of a rotor 10 used in a rotary electric machine 60 according to a first embodiment of the present invention. FIG. 2 is a cross sectional view of the rotary electric machine 60 along the line X-X in FIG. 1. For readily understanding of the invention, the length in the diameter direction in FIG. 2 is not the same proportion as that in FIG. 1, but is slightly exaggerated, and the thickness or the like of each electromagnetic steel plate is different proportion from the actual thickness.

The rotary electric machine 60 in this embodiment is a permanent magnetic synchronous rotary electric machine including a permanent magnet 16 embedded inside a rotor core 12. The rotary electric machine 60 includes the rotor 10 and a stator 62. The stator 62 comprises a substantially annular stator core 64 having a plurality of teeth formed along the inner circumference thereof, and a stator coil 66 wound around each tooth. The rotor 10 is mounted inside, concurrently with, the stator 62. A gap G is defined between the outer circumferential surface of the rotor 10 and the inner circumferential surface of the stator 62 so as to have a substantially uniform distance over their entire surfaces.

The rotor 10 has the rotor core 12, and the permanent magnet 16 embedded in the rotor core 12. A rotary shaft 50 is provided so as to penetrate the rotor core 12 at the center thereof while being supported rotatably relative to a case (not shown) via a bearing (not shown) or the like. The rotor 10 is rotatable together with the rotary shaft 50.

The rotor core 12 is formed by stacking a plurality of electromagnetic steel plates 14 in the rotor shaft direction. Each electromagnetic steel plate 14 is shaped like a disk and is a silicon electromagnetic steel plate, or the like, for example. A plurality of magnet slots 20 where to embed the permanent magnets 16 are formed near the outer circumference of the rotor core 12. Specifically, the plurality of magnet slots 20 are arranged uniformly in the circumferential direction of the rotor core 12, and each magnet slot 20 penetrates the rotor core 12 in the rotor shaft direction (in the vertical direction relative to the paper surface in FIG. 1).

In each magnet slot 20, the permanent magnet 16 is embedded, constituting a magnetic pole 18. Specifically, one magnetic pole 18 comprises a pair of permanent magnets 16 that are disposed in a posture of spreading toward the outer circumference of the rotor core 12 so as to define a substantial V shape. In this embodiment, sixteen permanent magnets 16; that is, eight magnetic poles 18, are provided near the outer circumferential end of the rotor core 12. Each permanent magnet 16 has a panel shape having a flat rectangular cross section whose length in the shaft direction is substantially the same as that of the rotor core 12. Note that the above-mentioned numbers of the permanent magnets 16 and the magnetic poles 18 are an example, and can be arbitrarily changed. Further, although in this embodiment a pair of permanent magnets 16 constitute one magnetic pole 18, one permanent magnet 16 may constitute one magnetic pole 18.

In the rotary shaft 50 and the rotor core 12, there is formed a refrigerant channel where refrigerant for cooling the rotor 10 and the stator 62 flows. The refrigerant channel includes roughly a shaft interior refrigerant path 52 formed inside the rotary shaft 50 and a core interior refrigerant path formed inside the rotor core 12. The shaft interior refrigerant path 52 is a hole that extends in the rotary shaft 50 at the center thereof. Specifically, the shaft interior refrigerant path 52 extends from one end of the rotary shaft 50 to the middle thereof in the shaft direction, and is then divided so as to respectively extend in the diameter direction toward the inner circumferential end of the rotor core 12. In the following, of the shaft interior refrigerant path 52, a refrigerant path extending in the shaft direction will be referred to as a “shaft direction refrigerant path 52a,” and a refrigerant path extending in the diameter direction will be referred to as a “diameter direction refrigerant path 52b.” In this embodiment, the diameter direction refrigerant path 52b is formed for every other magnetic pole because of the reason to be described later in detail.

The core interior refrigerant path includes refrigerant paths formed in three electromagnetic steel plates of two kinds that are positioned in the middle in the shaft direction in the rotor core 12. The two kinds of electromagnetic steel plates include a first steel plate 14a in which a first refrigerant path 22 and a second refrigerant path 24 are formed extending in the diameter direction, and two second steel plates 14b in each of which a third refrigerant path 26 is formed extending in the circumferential direction and which is mounted so as to sandwich the first steel plate 14a.

As shown in FIG. 2, the first steel plate 14a is positioned at the same position in the rotor shaft direction as that of the end portion of the shaft interior refrigerant path 52 so that the diameter direction refrigerant path 52b and the second refrigerant path 24 are in fluid communication with each other. Further, the inner circumferential end portion of the first refrigerant path 22 and the outer circumferential end portion of the refrigerant path 24 are in fluid communication with the respective end portions of the third refrigerant path 26. Therefore, a core interior refrigerant path extending from the second refrigerant path 24 to the third refrigerant path 26 and further to the first refrigerant path 22 is formed inside the rotor core 12.

Refrigerant is supplied from a refrigerant supply source provided outside the rotary electric machine 60 to the shaft interior refrigerant path 52 by a pump or the like. The refrigerant supplied to the shaft interior refrigerant path 52 then flows in the core interior refrigerant path to be discharged from the outer circumferential end of the rotor core 12 into the gap G. The discharged refrigerant flows in the gap G, and then drops to the bottom of the case of the rotary electric machine 60. The refrigerant having dropped to the bottom of the case is discretionally collected and cooled before being returned to the refrigerant supply source. Note that the refrigerant can be any liquid that can achieve preferable cooling performance relative to the rotor 10 and the stator 62, and is not limited to any particular liquid. In this embodiment, cooling oil is used as refrigerant.

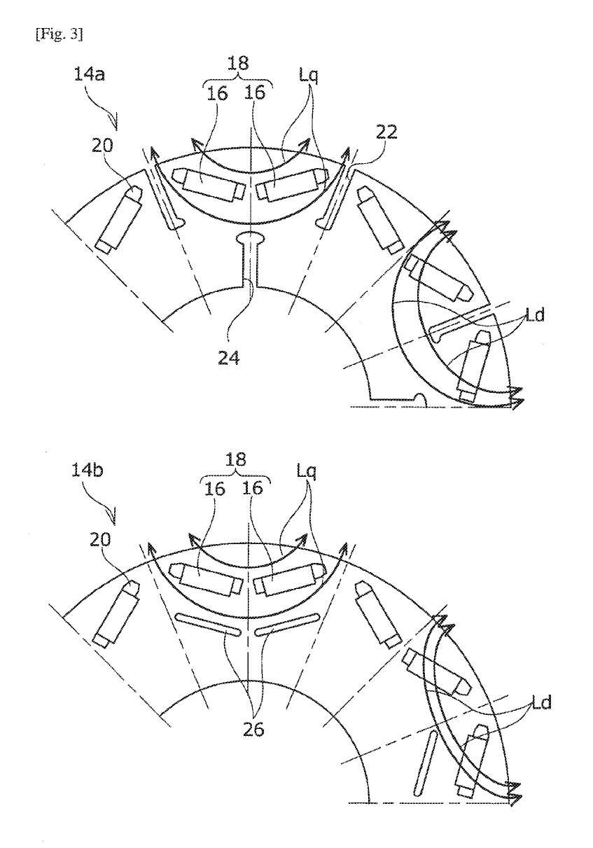

As is obvious from the above description, in this embodiment, the refrigerant flows sequentially from the inside of the rotary shaft 50 and then in the core and in the gap G. While the refrigerant flows, the rotor core 12, the magnet, and the stator core 64 are deprived of heat to be thereby cooled. In this embodiment, the core interior refrigerant path has a special structure in order to increase the cooling performance while preventing deterioration of the output performance of the motor. This will be described below in detail with reference to FIG. 3.

FIG. 3 shows a structure of the first steel plate 14a and that of the second steel plate 14b. In FIG. 3, an alternate long and short dash line indicates a d axis of the rotary electric machine 60; and a long dashed double-short dashed line indicates a q axis of the rotary electric machine 60. As described above, two kinds of refrigerant paths; namely, the first refrigerant path 22 and the second refrigerant path 24, are formed in the first steel plate 14a.

The first refrigerant path 22 is a slit that penetrates the first steel plate 14a. The first refrigerant path 22 extends along a q axis of the rotary electric machine 60; that is, an axis extending in the middle position between adjacent magnetic poles 18 (the middle position of a salient pole) and the rotor central axis. In this embodiment, the first refrigerant path 22 is formed for every magnetic pole. That is, the first refrigerant paths 22 are formed in the same number as the magnetic poles. The first refrigerant path 22 extends in the q axis direction from the outer circumferential end of the rotor core 12 toward the rotor inner circumference. The inner circumferential end portion of the first refrigerant path 22 is wider, as compared to the remaining part of the same.

The second refrigerant path 24 as well is a slit that penetrates the first steel plate 14a. The second refrigerant path 24 extends along a d axis of the rotary electric machine 60; that is, an axis extending in the middle position of each magnetic pole 18 (the middle position between two permanent magnets 16 constituting one magnetic pole 18) and the rotor central axis. In other words, the second refrigerant path 24 is displaced in the rotor circumferential direction relative to the first refrigerant path 22. In this embodiment, the second refrigerant path 24 is formed for every other magnetic pole. That is, the second refrigerant paths 24 are formed in the same number as the magnetic pole pairs (half the number of the magnetic poles). The second refrigerant path 24 extends along the d axis direction of the rotary electric machine 60 from the inner circumferential end of the rotor core 12 to a position closer to the inner circumference than the permanent magnet 16 is. The outer circumferential end portion of the second refrigerant path 24 is widened so as to have a substantial oval shape.

The third refrigerant path 26 is formed in the second steel plate 14b. The third refrigerant path 26 is a slit that penetrates the second steel plate 14b. The third refrigerant path 26 is a refrigerant path for providing fluid communication between the second refrigerant path 24 and the first refrigerant paths 22 positioned on the respective sides of the second refrigerant path 24. The third refrigerant path 26 is formed at a position closer to the inner circumference than the permanent magnet 16 is, and extends along the permanent magnet 16 so as to spread toward the outer circumference of the rotor core 12 so as to define a substantial V shape, similar to the permanent magnets 16. Specifically, as shown in FIG. 1, in this embodiment, a pair of third refrigerant paths 26 is formed with respect to one second refrigerant path 24 so as to spread in a substantial V shape. As the second refrigerant path 24 is provided for every other magnet pole, a pair of the third refrigerant path 26 as well is resultantly provided for every other magnetic pole. Further, as two third refrigerant paths 26 are provided with respect to one magnetic pole, the third refrigerant paths 26 are formed in the same number as the magnetic poles as a whole. One end portion of each third refrigerant path 26 is positioned overlapping the oval portion; that is, the outer circumferential end portion, of the second refrigerant path 24, and the other end portion of the same is positioned overlapping the inner circumferential end portion of the first refrigerant path 22.

When the second steel plate 14b is placed overlapping the first steel plate 14a, the third refrigerant path 26 is in fluid communication with the second refrigerant path 24 and the first refrigerant path 22. As is obvious from FIG. 1, the outer circumferential end portion of the second refrigerant path 24 overlaps one end portions of two third refrigerant paths 26 so that the two third refrigerant paths 26 are connected to the outer circumferential end portion of the one second refrigerant path 24. Moreover, the inner circumferential end portion of the first refrigerant path 22 overlaps the other end portion of one third refrigerant path 26 so that the one third refrigerant path 26 is connected to the inner circumferential end portion of the first refrigerant path 22.

As is obvious from FIG. 3, in this embodiment, a part between the end portions of two third refrigerant paths 26 adjacent to each other within one magnetic pole is narrow and thus likely to be weak in strength. In view of the above, in this embodiment, the end portion of the second refrigerant path 24 is formed wider so that two third refrigerant paths 26 can be linked to one second refrigerant path 24 while ensuring that the part between the end portions of the two adjacent third refrigerant paths 26 is as wide as possible.

The refrigerant having flown in one second refrigerant path 24 is divided to flow into four third refrigerant paths 26 formed in two respective second steel plates 14b, and thereafter into two first refrigerant paths 22. In order to keep uniform the pressure of the refrigerant flowing in the refrigerant paths 22, 24, 26, it is desirable that the first refrigerant path 22 has a width (a cross sectional area) about half of that of the second refrigerant path 24, and the third refrigerant path 26 has a width (a cross sectional area) about a quarter of that of the second refrigerant path 24. However, as a part along a q axis for formation of the first refrigerant path 22 is sandwiched by the magnet slots 20 and is thus very narrow, there may be a case in which a sufficiently wide refrigerant path cannot be ensured. Moreover, when the cross sectional area of the third refrigerant path 26 is excessively small, large surface resistance results, which may hinder smooth flow of refrigerant. In view of the above, it is desirable that the width (a cross sectional area) of each refrigerant path is adjusted in consideration of the strength of the rotor core 12, surface resistance (fluid resistance), and the like.

As is obvious from the above description, the core interior refrigerant path including the first, second, third refrigerant paths 22, 24, 26 extends along a d axis from the inner circumferential end of the rotor core 12, then is shifted in the rotor shaft direction at a position closer to the inner circumference than the permanent magnet 16 is before extending in the circumferential direction along the permanent magnet 16, and is shifted again in the rotor shaft direction at a position near a q axis before extending along the q axis until the outer circumferential end of the rotor core 12. That is, when the core interior refrigerant path is discretionally bent and shifted in the rotor shaft direction, as described above, it is possible to improve the cooling performance of the rotor 10 without deteriorating the output performance of the rotary electric machine 60. This will be described below in comparison with conventional art.

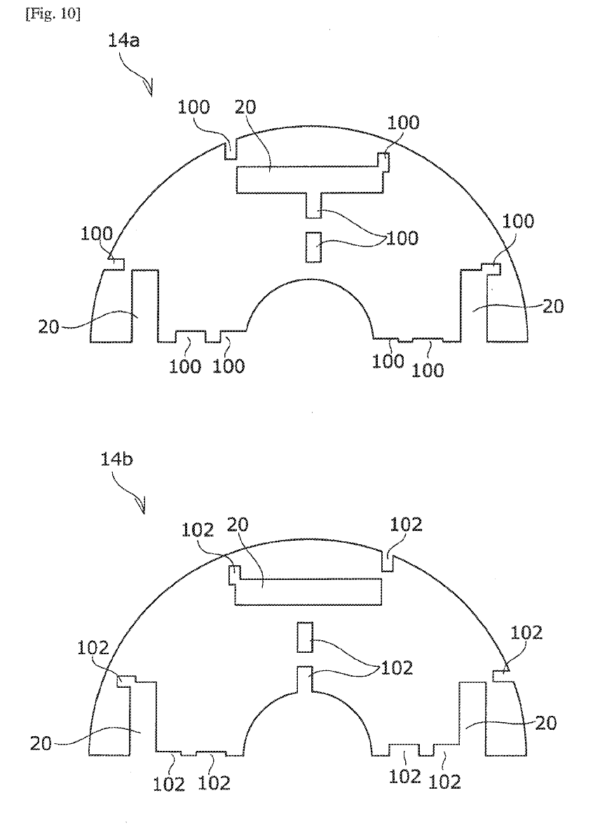

Conventionally as well, there has been proposed a technique for forming a refrigerant channel inside the rotor core 12 to cool the rotor 10 and the stator 62. Patent Document 1, for example, discloses that, as shown in FIG. 10, a refrigerant channel is formed in two electromagnetic steel plates 14a, 14b, using a plurality of slits 100, 102 extending in the diameter direction. In Patent Document 1, each of the plurality of slits 100, 102 is formed along a d axis of the rotary electric machine 60 in an area closer to the inner circumference than a magnet slot 20 is, and on either side of the magnet slot 20 in an area closer to the outer circumference than the magnet slot 20 is.

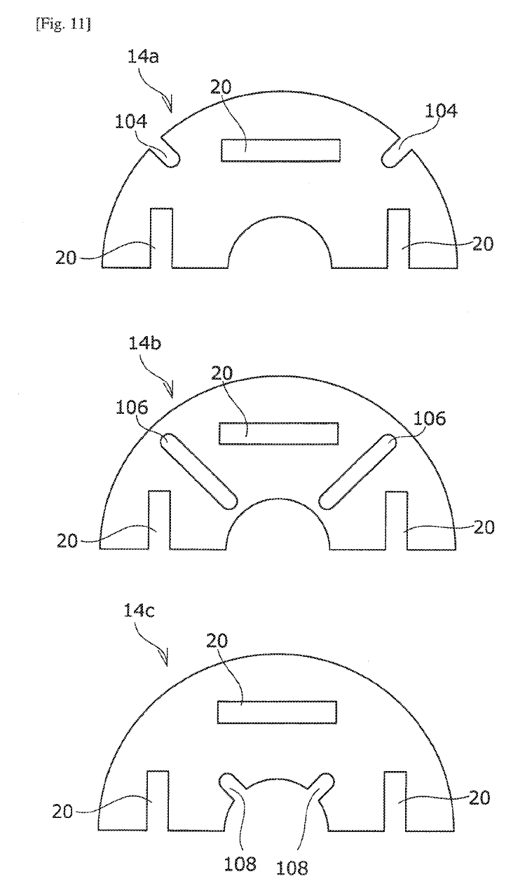

Patent Document 3 discloses that, as shown in FIG. 11, a refrigerant channel is formed in three respective electromagnetic steel plates 14a, 14b, 14c, using a plurality of slits 104, 106, 108 extending in the diameter direction. In Patent Document 3, each of the plurality of slits 104, 106, 108 is formed along a q axis of the rotary electric machine 60.

According to the conventional art, it is possible to cool the rotor 10 and the stator 62, as it is possible to discharge the refrigerant from the inside of the rotor core into the gap G. However, according to the conventional art, it is probable that one of the magnet torque and the reluctance torque may decrease. That is, as is known, an IPM rotary electric machine improves its output performance by utilizing both magnetic torque and reluctance torque due to the permanent magnet 16. In order to effectively utilize the magnetic torque, it is necessary to keep low the magnetic resistance in a magnetic path (hereinafter referred to as a “d axis magnetic path”) of flux linkage due to a d axis current. Meanwhile, in order to effectively utilize the reluctance torque, it is necessary to keep low the magnetic resistance in a magnetic path (hereinafter referred to as a “q axis magnetic path”) of flux linkage due to a q axis current.

In the above, the q axis magnetic path is a magnetic path that traverses a d axis of the rotary electric machine 60. Therefore, when the slit 100, 102 is formed along the d axis to form the refrigerant channel, as described in Patent Document 1, the slit 100, 102 with high magnetic resistance is resultantly positioned on the way of the q axis magnetic path, which results in a significant increase of the magnetic resistance in the q axis magnetic path and decrease of the reluctance torque. Meanwhile, the d axis magnetic path is a magnetic path that traverses a q axis of the rotary electric machine 60. Therefore, when the slit 104, 106, 108 is formed on the q axis to form the refrigerant channel, as described in Patent Document 3, the slit 104, 106, 108 with high magnetic resistance is resultantly positioned on the way of the d axis magnetic path, which results in a significant increase of the magnetic resistance in the d axis magnetic path and decrease of the magnet torque.

When the number of kinds of electromagnetic steel plates 14 for formation of the refrigerant channel is increased and the distance of a slit formed in each electromagnetic steel plate 14 is shortened, it is possible to ensure a sufficiently wide magnetic path, and accordingly, to prevent decrease of the magnet torque and the reluctance torque, even when the refrigerant channel is formed along a q axis or a d axis. In this case, however, it is necessary to prepare a plurality of kinds of electromagnetic steel plates 14 including slits formed therein at different positions, which results in a problem of increase of the number of kinds of components and of labor for assembling.

In addition, in Patent Documents 1, 3, a refrigerant path is formed for every magnetic pole. In this case, it is necessary to form the number of holes in proportion to the number of the magnetic poles in the electromagnetic steel plate. This deteriorates the strength of the electromagnetic steel plate itself and resultantly decreases the output and reliability of the rotary electric machine. Further, according to the technique disclosed in Patent Documents 1, 3, it is necessary to provide diameter direction magnetic paths in the rotary shaft that communicate with the core interior refrigerant paths in the same number as the magnetic poles. However, increase in the number of diameter direction magnetic paths results in deterioration of the torsional strength of the rotary shaft and may resultantly decrease the reliability of the rotary electric machine.

In this embodiment, in order to avoid such problems and to improve the cooling performance of the rotor 10 without deteriorating the output performance of the rotary electric machine 60, the core interior refrigerant path is arbitrarily bent and shifted in the rotor shaft direction. That is, as shown in FIG. 3, flux linkage due to a d axis current for generating magnet torque proceeds into the rotor core 12 while passing through the middle of one magnetic pole 18, and then through the middle of an adjacent magnetic pole 18 before exiting the rotor core 12. Therefore, the d axis magnetic path Ld results in a magnetic path that traverses a q axis of the rotary electric machine 60. In this embodiment, in order not to block the d axis magnetic path Ld, the third refrigerant path 26 extending in the circumferential direction and the first refrigerant path 22 extending along the q axis are formed in respective different electromagnetic steel plates 14, and the first refrigerant path 22 is formed halfway in the diameter direction of the electromagnetic steel plate 14. Therefore, in the first steel plate 14a, a part between the inner circumferential end of the first refrigerant path 22 and the inner circumferential end of the electromagnetic steel plate 14 can be used as the d axis magnetic path Ld. This makes it possible to ensure a wide d axis magnetic path. Further, in the second steel plate 14b, no refrigerant path is formed along the q axis, and accordingly, there is no refrigerant path that divides the d axis magnetic path Ld. As a result, it is possible to keep low the magnetic resistance in the d axis magnetic path Ld.

Meanwhile, flux linkage due to a q axis current for generating reluctance torque proceeds into the rotor core 12 from a salient pole formed between the magnetic poles 18 and then through an adjacent salient pole before exiting the rotor core 12. In this embodiment, in order not to block the q axis magnetic path Lq, the second refrigerant path 24 extending along the d axis is formed extending only until a position closer to the inner circumference than the permanent magnet 16 is, and the third refrigerant path 26 is formed extending in a position closer to the inner circumference than the permanent magnet 16 is. Therefore, in the first steel plate 14a, a part between the inner circumferential end of the second refrigerant path 24 and the permanent magnet 16 can be used as the q axis magnetic path Lq so that the q axis magnetic path Lq is not divided by the refrigerant path. Further, in the second steel plate 14b, as the third refrigerant path 26 extends in a direction substantially parallel to the flux linkage due to the q axis current, the q axis magnetic path Lq is not divided by the refrigerant path, and it is possible to ensure small magnetic resistance. That is, according to this embodiment, as neither the d axis magnetic path Ld nor the q axis magnetic path Lq is divided by the refrigerant path, it is possible to effectively utilize both magnetic torque and reluctance torque, and thus to prevent deterioration of the output performance of the rotary electric machine 60.

Further, in this embodiment, the second refrigerant path 24 is formed for every other magnetic pole. Therefore, it is possible to reduce the number of slots formed in each electromagnetic steel plate and to halve the number of the diameter direction refrigerant paths 52b, as compared to a case in which the second refrigerant path 24 is formed for every magnetic pole. As a result, it is possible to prevent excessive decrease of the strength of the electromagnetic steel plate, and thus decrease of the output and reliability of the rotary electric machine. Still further, as it is possible to reduce the number of the diameter direction refrigerant paths 52b, it is possible to improve the torsional strength of the rotary shaft 50, as compared to the conventional art.

Meanwhile, in this embodiment, the first refrigerant path 22 is provided for every magnetic pole, and the outer circumferential end of the first refrigerant path 22 forms an outlet of refrigerant into the gap G. That is, in this embodiment, the number of outlets of refrigerant into the gap G is the same as that of the magnetic poles, similar to the conventional art.

Note here, in the rotary electric machine 60, there is a requirement to effectively cool the permanent magnet 16, in particular, in the rotor 10 and the stator 6. This is because excessive increase of the temperature of the permanent magnet 16 results in not only decrease of magnetic torque but also demagnetization of the magnet, which deteriorates the performance of the rotary electric machine 60. Such demagnetization can be prevented when a magnet having high coercivity is employed. In this case, however, it is necessary to increase the content ratio of heavy rare earth elements, which increases cost.

In view of the above, cooling the permanent magnet 16 by flow of refrigerant is taken into consideration. The permanent magnet 16 is cooled to some extent while refrigerant flows in the rotor core 12. However, as the core interior refrigerant path is formed only in substantially the middle in the shaft direction, it is only possible to cool a part of the permanent magnet 16 near the middle in the shaft direction while the refrigerant flows. Meanwhile, the refrigerant poured into the gap G contacts over a wider area the outer circumferential surface of the rotor 10 and the inner circumferential surface of the stator 62 while flowing in the shaft direction. As a result, not only the permanent magnet 16 but also the rotor core 12 and the stator 62 are effectively cooled while the refrigerant flows in the gap G. This cooling effect is enhanced when a larger amount of refrigerant flows uniformly in the gap G.

In order to ensure a uniform flow of refrigerant in the gap G, it is necessary to uniformly provide many refrigerant outlets. In this embodiment, as the first refrigerant path 22 is formed for every magnetic pole, the refrigerant outlets are provided in the same number as the magnetic poles, similar to the conventional art. That is, according to this embodiment, it is possible to achieve cooling effect equivalent to that according to the conventional art, while reducing the number of refrigerant paths formed in the electromagnetic steel plate and the rotary shaft 50, as compared to the conventional art.

As is obvious from the above description, in this embodiment, the refrigerant channel for introducing refrigerant from the inner circumferential end of the rotor core 12 to the outer circumferential end is formed, using two kinds of electromagnetic steel plates 14a, 14b. Therefore, it is not necessary to prepare many electromagnetic steel plates including refrigerants paths formed therein in different positions, and thus it is possible to reduce the number of kinds of components and labor for assembling.

Further, in this embodiment, the core interior refrigerant path is formed only in one position in the rotor shaft direction. This structure can prevent refrigerant from pooling in the gap G to thereby reduce dragging loss. That is, in a case where a core interior refrigerant path is formed in two or more positions in the rotor shaft direction, refrigerant poured from one core interior refrigerant path into the gap G interferes with refrigerant poured from another core interior refrigerant path into the gap G. As a result, the refrigerant does not flow rapidly to be discharged to the outside of the gap G, but stays in the gap G. In this case, the refrigerant exerts rotation resistance of the rotor 10, which increases dragging loss. Meanwhile, in this embodiment, in which the core interior refrigerant flow path is formed only at one position in the rotor shaft direction, the refrigerant poured into the gap G from the core interior refrigerant channel is rapidly discharged to the outside of the gap G without interfering with other refrigerant flow. As a result, it is possible to reduce dragging loss, and to further improve efficiency of the rotary electric machine 60.

Note that although in this embodiment the second steel plate 14b including the third refrigerant path 26 formed therein is provided on either side of the first steel plate 14a including the first and second refrigerant paths 22, 24 formed therein; that is, two second steel plates 14b are provided, it may be the case that only one second steel plate 14b is provided. In a case where only one second steel plate 14b is provided, it is desirable that the third refrigerant path 26 formed in the second steel plate 14b has an accordingly wider width (a cross sectional area).

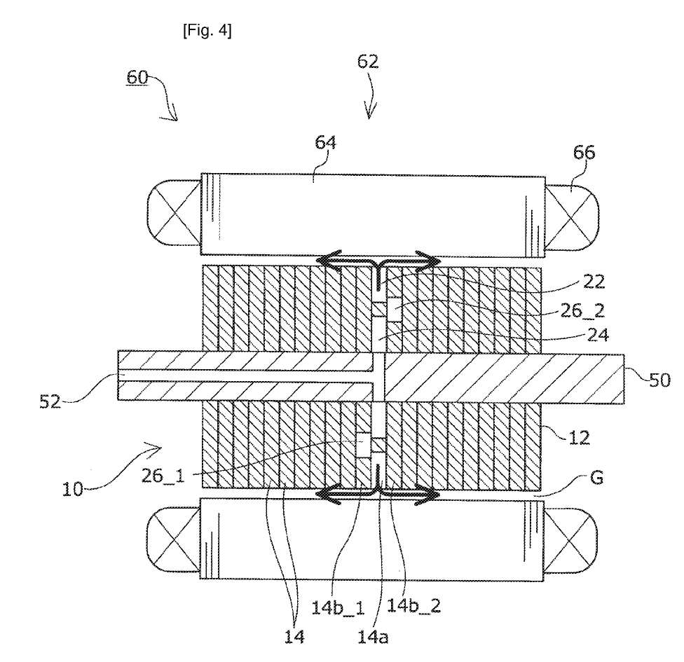

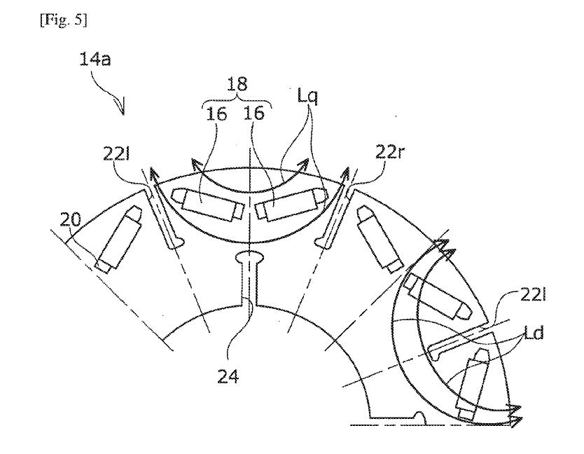

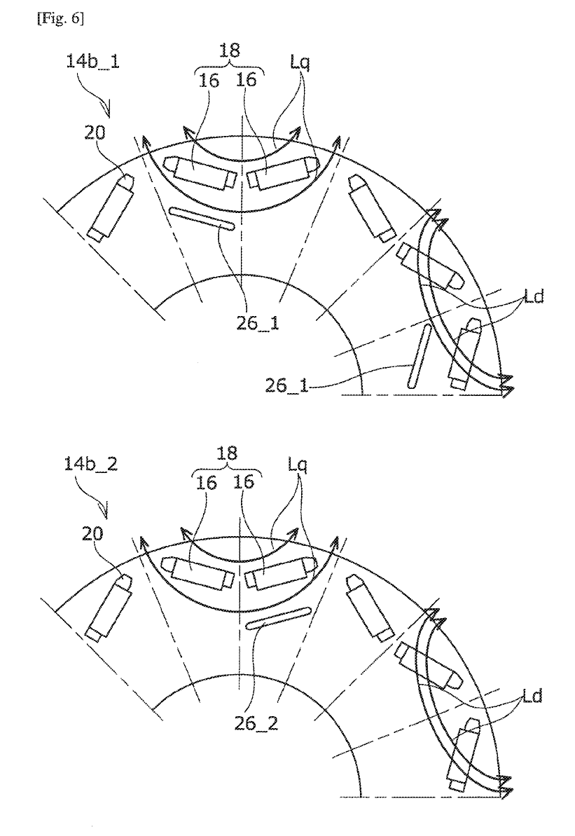

In the following, a second embodiment will be described by reference to FIGS. 4 to 6. FIG. 4 is a cross sectional view of a rotary electric machine 60 according to the second embodiment. FIG. 5 shows a structure of a first steel plate 14a used in the rotary electric machine 60. FIG. 6 shows structures of two kinds of third steel plates 14b_1, 14b_2 used in the rotary electric machine 60.

The rotor 10 of the rotary electric machine 60 is different from that in the first embodiment in that the third refrigerant path 26 is dividedly formed in two steel plates 14b_1, 14b_2. That is, in this embodiment, similar to the first embodiment, the core interior refrigerant path includes first refrigerant paths 22r, 22l and a second refrigerant path 24 formed in the first steel plate 14a, and a third refrigerant path 26 formed in the steel plates 14b_1, 14b_2 positioned on the respective sides of the first steel plate 14a in the shaft direction. Of these, the structure of the first steel plate 14a and thus those of the first refrigerant path 22 and the second refrigerant path 24 are the same as those in the first embodiment. In FIG. 5, the suffix r or l is appended to the reference numeral “22” of the first refrigerant path to facilitate the explanation below. The structure of the first steel plate 14a is the same as that in the first embodiment.

The third refrigerant path 26 is dividedly formed in the steel plates 14b_1, 14b_2 positioned on the respective sides of the first steel plate 14a in the shaft direction. That is, a one side third refrigerant path 26_1 is formed in the upper second steel plate 14b_1 positioned on the upper side (on the left side in FIG. 4) of the first steel plate 14a in the shaft direction, and an other side third refrigerant path 26_2 is formed in the lower second steel plate 14b_2 positioned on the lower side (on the right side in FIG. 4) of the first steel plate 14a in the shaft direction.

The one side third refrigerant path 26_1 is a refrigerant path for providing fluid communication between the second refrigerant path 24 and the first refrigerant path 22l adjacent to the second refrigerant path 24 on one side (on the left side in the circumferential direction in FIG. 5) thereof in the circumferential direction. The one side third refrigerant path 26_1 is provided for every other magnetic pole, and has a shape that extends toward the one side in the circumferential direction (on the left side in the circumferential direction in FIG. 6) as it goes from the inner circumferential side to the outer circumferential side.

Meanwhile, the other side third refrigerant path 26_2 is a refrigerant path for providing fluid communication between the second refrigerant path 24 and the first refrigerant path 22r adjacent to the second refrigerant path 24 on the other side (on the right side in the circumferential direction in FIG. 5) thereof in the circumferential direction. The other side third refrigerant path 26_2 is provided for every other magnetic pole, and has a shape that extends toward the other side in the circumferential direction (on the right side in the circumferential direction in FIG. 6) as it goes from the inner circumferential side to the outer circumferential side.

In a case where the steel plates are stacked such that the first steel plate 14a is sandwiched by the upper second steel plate 14b_1 and the lower second steel plate 14b_2, refrigerant is supplied to the first refrigerant path 22l on the one side through the second refrigerant path 24 and the one side third refrigerant path 26_1. Meanwhile, refrigerant is supplied to the first refrigerant path 22r on the other side through the second refrigerant path 24 and the other side third refrigerant path 26_2.

In this embodiment as well, as the first refrigerant path 22 and the third refrigerant paths 26_1, 26_2 are formed in different electromagnetic steel plates, the d axis magnetic path Ld and the q axis magnetic path Lq are not divided by the refrigerant path. As a result, it is possible to effectively utilize both magnet torque and reluctance torque, and thus to prevent deterioration of the output performance of the rotary electric machine 60.

Further, in this embodiment, the third refrigerant paths 26_1 and 26_2 are formed for every other magnetic pole, and the third refrigerant paths 26_1 or 26_2 are formed in one second steel plate 14b_1, 14b_2 in a number equal to half that of the magnetic poles. This number is half of the number of the refrigerant paths formed in one second steel plate 14b in the first embodiment. Therefore, the number of refrigerant paths is fewer in this embodiment, as compared to the first embodiment, which enhances the core strength. Meanwhile, the number of refrigerant outlets into the gap G (the outer circumferential end of the first refrigerant path 22) is the same as that in the first embodiment. As a result, according to this embodiment, it is possible to achieve cooling effect equivalent to that in the first embodiment, while improving the core strength.

As is obvious from FIG. 6, the upper second steel plate 14b_1 and the lower second steel plate 14b_2 have a mirror image relationship. That is, the upper second steel plate 14b_1 and the lower second steel plate 14b_2 are steel plates having a fully identical structure but placed laterally flipped relative to each other. In other words, the upper second steel plate 14b_1 and the lower second steel plate 14b_2 are the same kind of steel plates but stacked in a laterally flipped manner. That is, in the second embodiment as well, the number of kinds of steel plates for formation of the core interior refrigerant path is two (the first steel plate 14a and the second steel plate 14b). Therefore, in this embodiment as well, similar to the first embodiment, it is not necessary to prepare many electromagnetic steel plates including refrigerants paths formed therein in different positions, and therefore it is possible to reduce the number of kinds of components and labor for assembling.

Note that the above-described structure is one example. So long as there are included at least the first refrigerant path 22 extending along a q axis from the outer circumferential end of the rotor core 12 to inside the rotor core 12, the second refrigerant path 24 positioned displaced in the circumferential direction relative to the first refrigerant path 22 and extending from the inner circumferential end of the rotor core 12 to inside the rotor core 12, and the third refrigerant path 26 positioned displaced in the shaft direction relative to the first refrigerant path 22 and extending in the circumferential direction to connect the first refrigerant path 22 and the second refrigerant path 24, the first refrigerant path 22 is formed for every magnetic pole, and the second refrigerant path 24 is formed for every other magnetic pole, the structure of the remaining part can be arbitrarily modified.

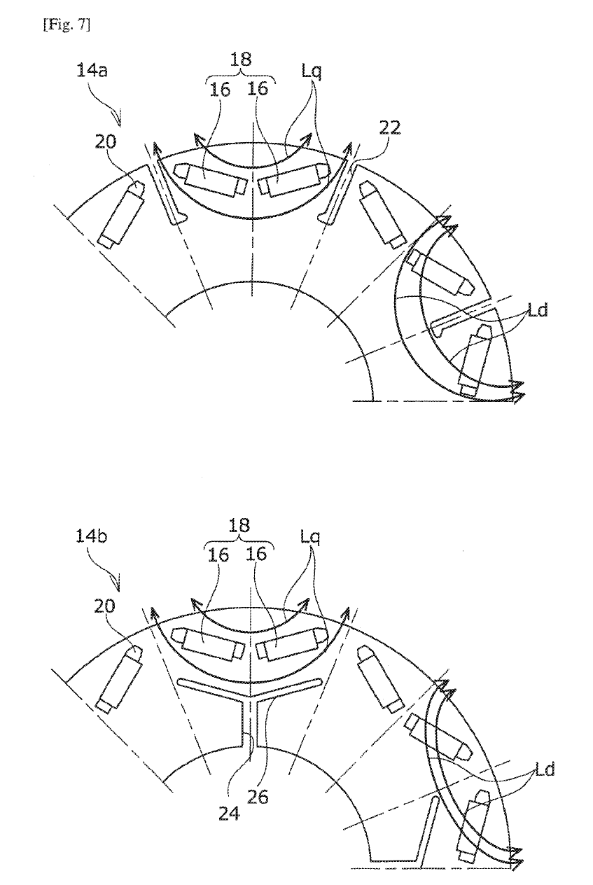

For example, like the first refrigerant path 22 and the third refrigerant path 26 formed in different electromagnetic steel plates 14, the first refrigerant path 22, the second refrigerant path 24, and the third refrigerant path 26 may be each formed in different electromagnetic steel plates 14. Alternatively, the second refrigerant path 24 may be formed in the electromagnetic steel plate 14 including the third refrigerant path 26 formed therein. That is, as shown in FIG. 7, it may be the case that only the first refrigerant path 22 is formed in the first steel plate 14a, and the second refrigerant path 24 and the third refrigerant path 26 are formed in the second steel plate 14b. As another example, it may be the case that the second refrigerant path 24 and the one side third refrigerant path 26_1 are formed in the upper second steel plate 14b_1, and the second refrigerant path 24 and the other side third refrigerant path 26_2 are formed in the lower second steel plate 14b_2.

Note that although in the above description a refrigerant path is formed using a slit that penetrates the electromagnetic steel plate 14, a groove that does not penetrate the electromagnetic steel plate 14 may be used, instead of a slit, to form the refrigerant path. Further, a plurality of first steel plates 14a or second steel plates 14b may be stacked to thereby adjust the thickness (the length in the shaft direction) of each refrigerant path 22, 24, 26. For example, a first steel plate set including a plurality of first steel plates 14a stacked and a second steel plate set including a plurality of second steel plates 14b stacked may be disposed adjacent to each other in the rotor shaft direction. Further, the second steel plate set may be disposed on either side of the first steel plate set in the rotor shaft direction. Still further, although in this embodiment only the rotor core 12 that is made using stacked steel plates including the electromagnetic steel plates 14 stacked is described as an example, the rotor core 12 may be made using any material, such as powder magnetic core, for example, other than stacked steel plates, so long as the resultant rotor core 12 can bear appropriate strength and magnetic properties.

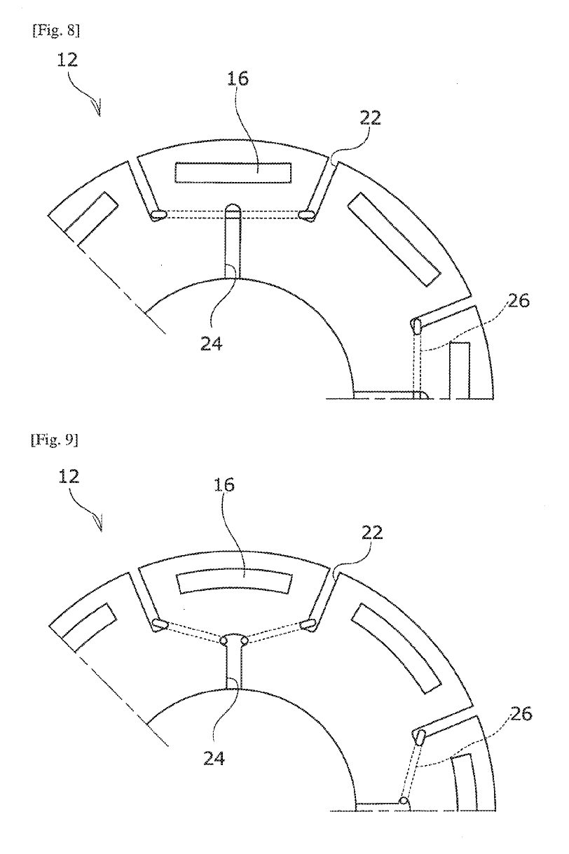

Further, although in this embodiment the second refrigerant path 24 is formed along a d axis, the position of the second refrigerant path 24 is not limited to being along a d axis, and the second refrigerant path 24 may be formed at any other position so long as the position is displaced in the rotor circumferential direction relative to the first refrigerant path 22. Still further, although in the above description only the rotor 10 including the permanent magnets 16 arranged in a V shape is described as an example, the shape of the permanent magnet 16 may be rectangular or arc, as shown in FIGS. 8 and 9, so long as the rotor 10 includes the permanent magnet 16 embedded in the rotor core 12. Yet further, although in the embodiment shown in FIG. 1 the third refrigerant path 26 is divided on a d axis (on the major axis of the second refrigerant path 24), the third refrigerant path 26 may be continuous, so long as the third refrigerant path 26 extends in the rotor circumferential direction and can connect the first refrigerant path 22 and the second refrigerant path 24. For example, as shown in FIG. 8, the third refrigerant path 26 may be a refrigerant path not divided on a d axis but continuously extending from one q axis to an adjacent q axis. Nevertheless, it is desirable that the third refrigerant path 26 is divided on a d axis, in order to ensure sufficient strength of the electromagnetic steel plate 14.

In any case, any structure is applicable so long as the structure includes the first refrigerant path 22 extending along a q axis from the outer circumferential end of the rotor core 12, the second refrigerant path 24 extending from the inner circumferential end of the rotor core 12, and the third refrigerant path 26 positioned displaced in the rotor shaft direction relative to the first refrigerant path 22 and in fluid communication with the first refrigerant path 22 and the second refrigerant path 24, the first refrigerant path 22 is formed for every magnetic pole, and the second refrigerant path 24 is formed for every other magnetic pole. This structure can keep low the magnetic resistance in both of the q axis magnetic path and the d axis magnetic path. Moreover, it is possible to achieve high cooling performance while maintaining high strength of the electromagnetic steel plate and the rotary shaft 50. As a result, it is possible to enhance the cooling performance of the rotor 10 without deteriorating the output performance of the rotary electric machine 60.

### REFERENCE SIGNS LIST

10 rotor
12 rotor core
14 electromagnetic steel plate
14a first steel plate
14b second steel plate
16 permanent magnet
18 magnetic pole
20 magnet slot
22 first refrigerant path
24 second refrigerant path
26 third refrigerant path
50 rotary shaft
52 shaft interior refrigerant path
52a shaft direction refrigerant path
52b diameter direction refrigerant path
60 rotary electric machine
62 stator
64 stator core
66 stator coil
100, 102, 104, 106, 108 slit
G gap
Ld d axis magnetic path
Lq q axis magnetic path.

1. A rotor of a rotary electric machine, including a rotor core and a permanent magnet embedded in the rotor core and being rotatably supported by a rotary shaft, wherein the rotor core includes a core interior refrigerant path formed therein for introducing refrigerant supplied from a shaft interior refrigerant path formed in the rotary shaft to an outer circumferential end of the rotor core to discharge into a gap defined between the outer circumferential end and a stator, and the core interior refrigerant path includes a first refrigerant path formed for every magnetic pole of the rotary electric machine and extending along each q axis of the rotary electric machine from the outer circumferential end of the rotor core toward an inner circumference of the rotor core; a second refrigerant path formed for every other magnetic pole of the rotary electric machine, and extending in a position displaced in a rotor circumferential direction relative to the first refrigerant path from an inner circumferential end of the rotor core to a position closer to the inner circumference than the permanent magnet is; and a third refrigerant path extending in the rotor circumferential direction in a position displaced in a rotor shaft direction relative to the first refrigerant path to provide fluid communication between the first refrigerant path and the second refrigerant path.

2. The rotor of a rotary electric machine according to claim 1, wherein the core interior refrigerant path is formed at only one position in the rotor shaft direction.

3. The rotor of a rotary electric machine according to claim 1, wherein the second refrigerant path extends along a d axis of the rotary electric machine.

4. The rotor of a rotary electric machine according to claim 1, wherein the rotor core is formed by stacking a plurality of electromagnetic steel plates in the rotor shaft direction, and a first steel plate including the first refrigerant path formed therein or a first steel plate set including a plurality of first steel plates stacked and a second steel plate including the third refrigerant path formed therein or a second steel plate set including a plurality of second steel plates stacked are disposed adjacent to each other in the rotor shaft direction.

5. The rotor of a rotary electric machine according to claim 4, wherein the third refrigerant path includes a one side third refrigerant path for providing fluid communication between the second refrigerant path and a first refrigerant path positioned adjacent to the second refrigerant path on one side of the second refrigerant path in the rotor circumferential direction and an other side third refrigerant path for providing communication between the second refrigerant path and a first refrigerant path positioned adjacent to the second refrigerant path on an other side of the second refrigerant path in the rotor circumferential direction, and the one side third refrigerant path and the other side third refrigerant path are formed in different electromagnetic steel plates.

6. The rotor of a rotary electric machine according to claim 5, wherein a one side second steel plate including the one side third refrigerant path formed therein or a steel plate set including a plurality of one side second steel plates stacked and an other side second steel plate including the other side third refrigerant path formed therein or a steel plate set including a plurality of other side second steel plates stacked are disposed on respective sides in the rotor shaft direction of the first steel plate including the first refrigerant path formed therein or the first steel plate set including the plurality of first steel plates stacked.

7. The rotor of a rotary electric machine according to claim 6, wherein the other side second steel plate is a steel plate resulting from stacking a steel plate having the same shape as the one side second steel plate so as to be laterally flipped relative to the one side second steel plate.

8. The rotor of a rotary electric machine according to claim 3, wherein the first refrigerant path and the second refrigerant path are formed in the same electromagnetic steel plate.
